(19) United States
(12) Patent Application Publication
(10) Pub. No.: US 2009/0310801 A1
(43) Pub. Date: Dec. 17, 2009

(54) Microphone, Flexible Boom and Stand

(75) Inventors: Lawrence E. Blakely, Meridian, MS (US); Dennis Hurd, Lunenburg, MA (US); William A. Simoneau, Hancock, NH (US)

Correspondence Address: GROSSMAN, TUCKER, PERREAULT & PFLEGER, PLLC, 55 SOUTH COMMERICAL STREET, MANCHESTER, NH, 03101, US

(73) Assignee: EARTHWORKS, INC., Milford, NH (US)

(21) Appl. No.: 12/483,158

(22) Filed: Jun. 11, 2009

Related U.S. Application Data
(60) Provisional application No. 61/061,391, filed on Jun. 13, 2008.

(51) Int. Cl. H04R 3/00

(52) U.S. Cl. 381/122

(57) ABSTRACT

A microphone system includes an elongated portion having a proximal end and a distal end defining a channel therethrough. The elongated portion comprises at least one relatively rigid section and at least one relatively flexible section. In addition, a base may be affixed to the proximal end of the elongated portion and a microphone may be affixed to the distal end of the elongated portion.

### CROSS REFERENCES TO RELATED APPLICATIONS

This application claims the benefit of the filing date of U.S. Provisional Application No. 61/061,391 filed on Jun. 13, 2008, the disclosure of which is incorporated herein by reference.

### FIELD OF THE INVENTION

The present invention relates generally to microphones and microphone stands and, in particular, a low profile microphone system that includes an integrated microphone, flexible boom and stand, wherein any wires may be relatively invisible above floor level.

### BACKGROUND

Microphone stands are commonly used to attach and hold or position microphones. Stands may be relatively adjustable up or down and the microphone may be pivoted around an axis. A stand may also include a boom, which may increase the reach or range of motion around or along a limited number of axes. However, the stand and/or boom may not be easily positioned requiring adjustment at one or more locations. In addition, the adjustment may require the use of two hands to position and lock the stand and/or boom into place. In addition, the stand and/or boom may be relatively high profile, requiring a large foot print to accommodate the reach of the stand and/or boom. Furthermore, unless the microphone is cordless, one must consider the microphone wire or cable, which may either be left dangling or visibly wrapped around the stand and/or boom in an unsightly manner.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a side view of an example of a microphone system contemplated herein;

FIG. 2a is side view of an example of a base;

FIG. 2b is a top view of the base of FIG. 2a;

FIG. 2c is a bottom view of the base of FIG. 2a;

FIG. 3 is a cross-sectional view of an example of a portion of a microphone system contemplated herein; and

FIG. 4 is a side view of an example of a microphone system contemplated herein, wherein the microphone system is folded over to accommodate a relatively low positioning of the microphone.

### SUMMARY

An aspect of the present disclosure relates to a microphone system that may include a base section, an elongated stand portion comprising one or more rigid section, such as a fixed tube, one or more flexible sections, such as a gooseneck or joint, and a microphone affixed to the stand portion. The elongated portion of the system may provide a channel enclosing and concealing any required electrical cable. Another aspect of the present disclosure relates to the electrical connection of the microphone portion of the system, specifically a connector that combines the functionality of a mechanical microphone connector, or clip, with an electrical microphone connector. According to this aspect, the microphone cable may be concealed within the channel in the stand and terminated at another electrical connector on or near the base. Such a connector may be an XLR connector.

Another aspect of this invention relates to a microphone stand system wherein the microphone may utilize a wireless connection.

A further aspect of this invention relates to the interaction of the rigid and flexible portions of the stand portion of the system. In particular, a rigid portion may incorporate a slidable rigid sleeve that may extend over some part or all of an adjacent flexible portion thereby preventing it from flexing, allowing the user to convert a section of the flexible portions to effectively act as a rigid portion as needed. This sleeve may be concentric to the rigid section.

### DETAILED DESCRIPTION

It is to be understood that this disclosure is not limited in its application to the details of construction and the arrangement of components set forth in the following description or illustrated in the drawings. The embodiments herein are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present disclosure relates to a system including a microphone and a microphone stand and/or boom (herein after referred to as stand). The microphone system may include a base portion, one or more flexible portions and/or a microphone head or elements. In addition, the system may include a connector and a series of wires for connecting the microphone to further processing electronics, (i.e., a microphone mixer, a preamplifier, sound or recording systems and/or other electronic devices).

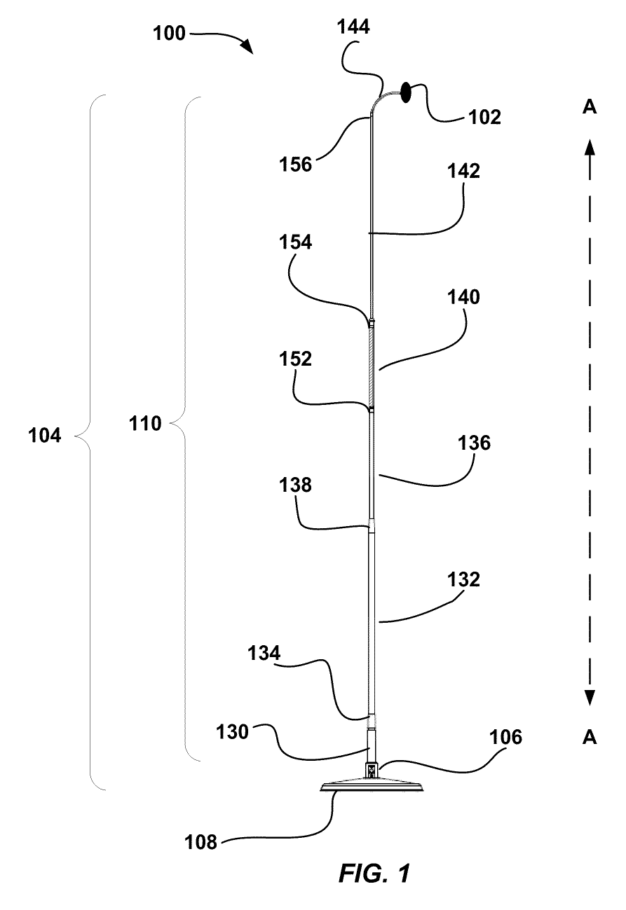

An example of such a system is illustrated in FIG. 1. The system 100 may include an acoustic to electric sensor/converter or a microphone 102, which may be supported by a stand 104. The wires of the microphone 102, if so provided, may be positioned within a channel or tube defined within or on the stand 104. The stand may also include a connector 106 integrated therein for connecting the microphone wires to a sound reinforcement or recording system, such as a preamplifier, microphone mixer, etc.

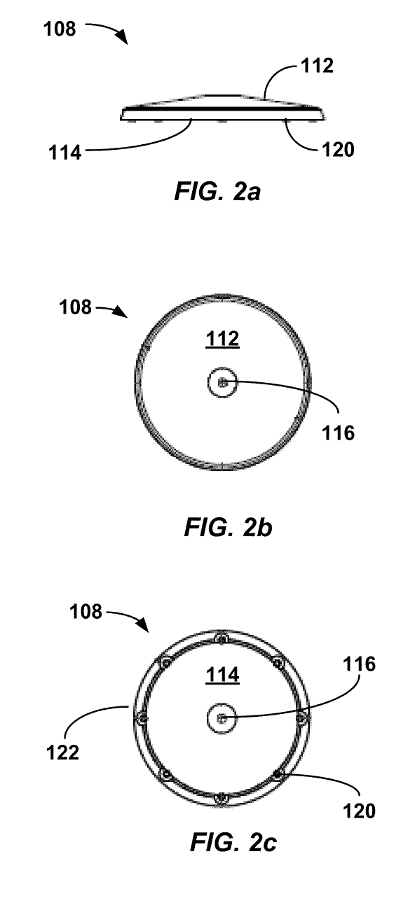

The stand 104 may include a base 108 and an elongated portion 110 extending from the base 108 to a microphone 102. The base 108 may be integrated into the elongated portion 110 or removable from the elongated portion. The base 108, illustrated further in FIGS. 2a, b and c, may include a top portion 112 and a bottom portion 114. The top portion 112 may have an opening 116 defined therein for receiving the elongated portion 110. The opening may pass through to the bottom portion 114, defining a bore therethrough, or may define a recess. The opening may be threaded and receive threads defined in the elongated portion allowing for the height of the elongated portion to be adjusted relative to the base. In another example, the opening may have a mount or fastener, such as a bayonet mount or a twist-lock type fastener, which may retain and/or apply a bias to the elongated portion.

The bottom portion 114 of the base 108 may include a number of feet 120, which may slightly raise the base from a surface, such as a floor. The feet may be positioned around the circumference 122 of the base or may project anywhere from the bottom portion 114. The feet may be integrated into the base or may be affixed to the base, such as in a removable manner. The feet may include a relatively slip resistant material or a vibration dampening material exhibiting a relatively low hardness, which may prevent scratching of a surface and/or prevent picking up vibrations from the floor or other surface. For example, the feet may exhibit a Shore hardness of less than 95.0 measured on the Shore A scale, including all values and increments in the range of 10.0 to 95.0.

The base may be 10 cm to 100 cm in diameter, including all values and increments therein. In addition, the base may include one or more weights. The weights may be removable from the base. Or the base may be constructed of a relatively heavy material. It may be appreciated that such weight or heavy material may counteract or balance the weight of the microphone regardless of its position relative to the base.

The elongated portion 110 may include a number of sections, which may form a hollow tube or channel. The sections may include relatively stiff sections and relatively flexible sections, wherein the relatively stiff sections may remain rigid and the relatively flexible sections may be bendable or deformable around or along one or more axes. For example, as illustrated in FIG. 1, the stand may include a first section 130 proximal to the base 108, including a connector 106 and a device for affixing the stand 104 to the base 108, such as threads or projections for being received in either a twist lock or bayonet mount, as alluded to above. The first section of the stand may be 2 cm to 5 cm in diameter, including all values and increments therein.

A second section 132 may be provided that may be relatively rigid. The second section of the stand may be 1.0 cm to 5.0 cm in diameter, including all values and increments therein. To transition between the first and second sections, 130 and 132, a collar 134 may be provided which may exhibit a reduction in the diameter of the interior surface of the collar from one end to the other. However, it may be appreciated that that first 130 and second 132 sections may be integrated together into a single section.

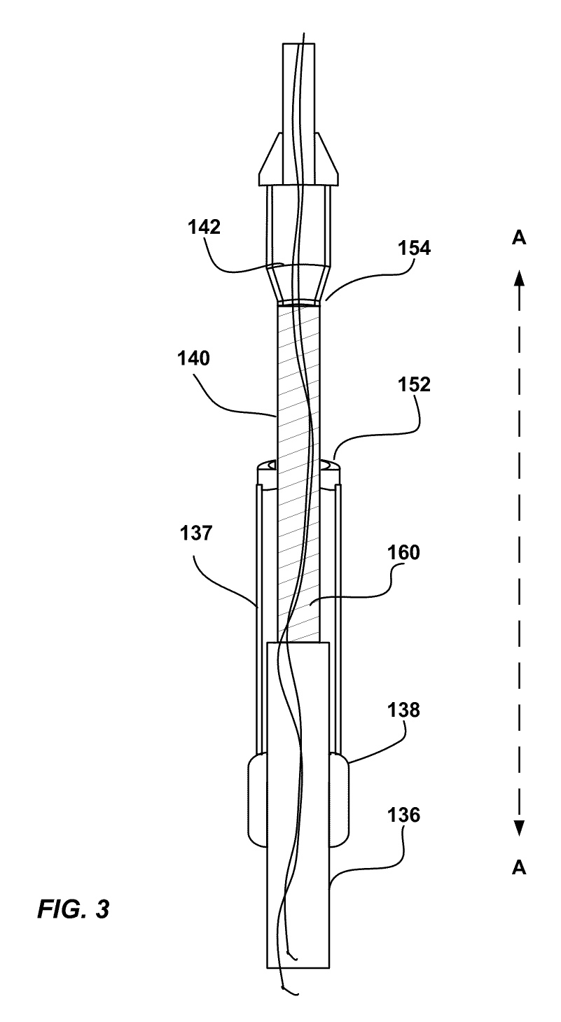

A relatively rigid third section 136 may also be provided and have a diameter in the range of 0.3 cm to 5 cm in diameter, including all values and increments therein. As illustrated in FIG. 3, the third section may include a sleeve 137 which may slide distal and proximal to the base 108 along axis A-A over inner tube section 136. As the sleeve is slid upwardly or distal from the base, the sleeve may cover the relatively flexible section 140 described below, preventing the relatively flexible section from bending along the length covered by the sleeve 137. The sleeve 137 may mate with and/or interlock with collar 154, wherein collar 154 may retain the sleeve in an upwards position or a position distal from the base. For example, the interior diameter of the sleeve 137 may be the same size or slightly larger than the exterior diameter of the lower portion of collar 154 allowing for the sleeve to fit over the lower portion of collar 154 and/or form an interference fit or mate with collar 154. As may be appreciated, by adjusting the sleeve 137 to the uppermost position, the sleeve may straighten out the relatively flexible section 140, such that the relatively flexible section may be covered by the relatively rigid sleeve providing substantial uniformity, particularly amongst one or more microphone systems. Accordingly, when it may be necessary to straighten the flexible section 140 proximal to the sleeve, (such as in the case of extending the microphone) adjusting the sleeve 137 over the flexible portion 140 may overcome the need to make sure that the flexible portion 140 is straight from all angles as the sleeve 137 may provide such guidance. It may be appreciated that the sleeve 137 may be substantially concentric to the inner tube section 136. The sleeve may be adjusted using collar 138, which may include a clutch or other device, such as threads or projections. The collar 138 may be used to lock and/or retain the sleeve 137 in place. For example, the collar may include a knurled clutch. It is noted that FIG. 3 also illustrates the microphone or element wires 160 passing through the central hollow portion of the microphone stand.

Referring again to FIG. 1, the fourth, relatively flexible section 140 may have a diameter in the range of 0.3 cm to 5.0 cm, including all values and increments therein. A fifth section 142 may be provided that may remain relatively rigid and a relatively flexible sixth section 144 may be provided to which the microphone 102 may be attached distally from the base. The fifth section 142 may have a diameter in the range of 0.25 cm to 3.0 cm, including all values and increments therein and the sixth section may have a diameter in the range of 0.2 cm to 3.0 cm, including all values and increments therein. Collars 152, 154, 156 may be present to provide a transition between the sections and/or affix one section to the next may be provided in between the fourth, fifth and sixth sections. However, it may be appreciated that the various sections may be integrated into each other and collars may not be necessary. For example, the unit molded into a single piece or unit. The various sections may also be affixed in place by crimps formed in overlapping portions of the sections, protrusions provided in one section that fit into depressions or holes provided in another section, threading each section, etc.

While the above arrangement includes four relatively stiff sections and two relatively flexible sections, it may be appreciated that a number of arrangements of flexible and non-flexible sections may be provided. More or less sections may be provided as well, such as three, seven or eight sections, provided that at least two or more flexible sections are present. In addition, one or more sections, such as the second 132, third 136 or fifth section 142, may be provided as a telescoping section including two or more sections which may slide together to lengthen or decrease the fifth section 142.

It may be appreciated that, in one example, the diameters of the various sections may be reduced along axis A-A approaching the microphone and distal from the base. In other embodiments, the diameters of the various sections may be maintained the same. The maximum diameter of the stand may be 6.0 cm or less, including all values therein, such as in the range of 0.10 cm to 5.81 cm. In addition, the microphone stand may be up to 400 cm in height, relative to the bottom of the base, including all values and increments therein, such as in the range of 45 cm to 215 cm. The microphone may also be positioned as low as 1 cm and up to 400 cm, relative to the bottom of the base, including all values and increments therein, upon bending, further described below.

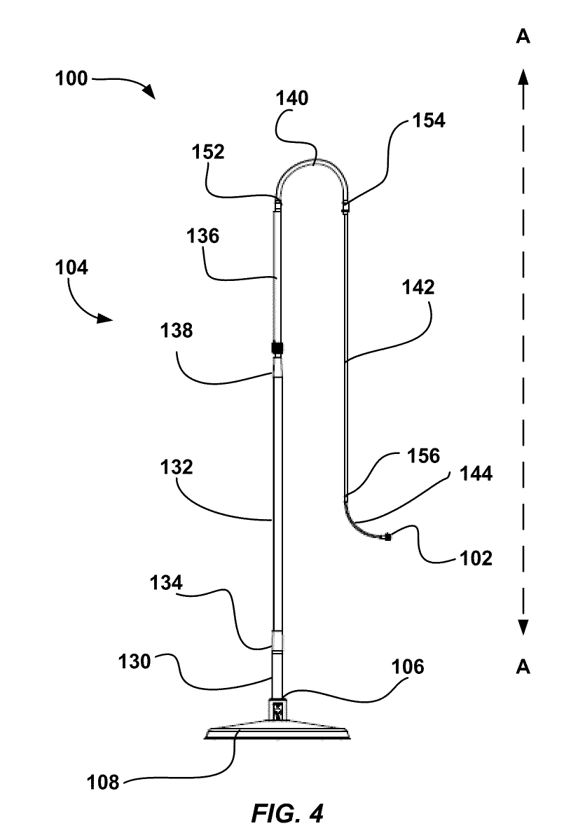

As illustrated in FIG. 4, the stand 104 may be capable of being configured such that the stand may bend in at least one or more places, including two places, three places, etc. In the illustrated example, the bends may be provided in the fourth section 140 and in the sixth section 144. However, other sections may be flexible instead of, or in addition to, the fourth or sixth sections. The stand may be capable of folding over or being positioned at one or more angles in one or more directions in each flexible section relative to, for example, the preceding section, such as the third or fifth sections as illustrated. In addition, it may be appreciated that in many cases, the position of the microphone may be adjusted using just one hand.

The relatively rigid sections may be formed from a metal, metal alloy and/or polymer material, such as an aluminum, aluminum alloy, stainless steel, polycarbonate, nylon, etc. In addition, one or more relatively rigid sections may be formed from a pipe, tube or channel.

The relatively flexible sections may also be formed of a metal, metal alloy and/or a polymer material, such as thermoplastic elastomers, synthetic rubber, vinyl, copper wire, shape memory alloys, etc. The relatively flexible sections may be flexible due to mechanical joints, such as one or more swivel joints positioned in the relatively flexible section, or due to the use of a material which may exhibit a relatively low flexural or elastic modulus. For example, the relatively flexible sections may be formed of flexible gooseneck tubing, which may be formed of a metal, such as a spring, and may include a polymer layer covering at least a portion of the tubing. The relatively flexible section may also include a filler or lubricant, such as a graphite, fluoropolymer or silicone filler or lubricant, which may prevent squeaking or other noises caused by bending the tubing.

In one example, the relatively rigid sections may be formed of a material having a first flexural modulus F₁ of greater than about 1.5 GPa, including all values and increment in the range of 1.5 GPa to 50 GPa. The relatively flexible sections may have a second flexural modulus F₂ of less than 2.0 GPa, including all values and increments in the range of 0.010 GPa to 2.0 GPa. The flexural modulus of the relatively rigid section F₁ may be greater than the flexural modulus of the relatively flexible section F₂, wherein F₁>F₂.

In another example, the relatively rigid sections may generally be formed from materials having a modulus of elasticity M₁ and the relatively flexible sections may generally have a modulus of elasticity M₂, wherein M₁>M₂. In one example, the relatively rigid sections may exhibit a relatively high modulus of elasticity, such as 1 GPa or greater, including all values and increments in the range of 1.0 to 40 GPa. The relatively flexible sections may exhibit a relatively low modulus of elasticisty, such as less than 1 GPa, including all values and increments in the range of 0.01 GPa to 0.9 GPa.

However, as alluded to above, the flexibility of the relatively flexible sections may be due to mechanical joints allowing the relatively flexible sections to move, rather than due to the flexibility of the material itself. The joints may include ball and socket joints, pivot joints, sliding joints, etc. The relatively rigid portions may not include such joints but may be able to rotate about an axis or slide up and down an axis, as described above.

Referring again to FIG. 1, the microphone 102 may be a condenser or capacitor type microphone. Vibrations produced by sound may cause a diaphragm to vibrate and change the distance between the diaphragm and a stationary plate, acting as a capacitor. The microphone may also include dynamic microphones, electret microphones, piezoelectric microphones, microelectrical-mechnical microphones, ribbon microphones, optical microphones, multichannel surround sound matrix microphones, etc. The microphone may exhibit an omnidirectional, subcardioid, cardioid, figure-8, supercardioid or hypercardioid directionality polar patterns or may include a multi-pattern microphone, which may include combinations of these patterns as well as multichannel microphones. For example, the microphone may exhibit a 1 Hz to 150 kHz frequency response at ±5 dB at 6 inches, including all values and ranges therein, such as a 30 Hz to 30 kHz frequency response. In addition, the microphone may exhibit a 175 dB SPL (sound pressures level relative to 20 micropascals) max acoustic input at 0.5% to 3% THD (total harmonic distortion) or less. In addition, more than one microphone or sensors may be provided, allowing for multi-channel input, such as stereo, quadraphonic, or even multichannel surround sound setups including those which may be matrixed.

The microphone 102 may also be removably affixed to the stand 104 so as to allow for interchangability of the microphone 102. A mount, such as a bayonet mount, or threads may be provided so that the microphone may be removed and/or attached to the stand. In addition, an electrical connection may be provided to connect the microphone electrically to a connector, described herein. The electrical connection may be held in place at the distal portion of the stand 104, such that when the microphone is affixed to the stand, the electrical connector may automatically connect to the microphone. It may also be appreciated that the electrical connector may be removed or adjusted and connected to the microphone prior to affixing the microphone to the stand.

As alluded to above, the microphone 102 may be connected to auxiliary systems via a number of wires (illustrated in FIG. 3), which may pass through the inside of the microphone stand 104 and provide electrical communication between the microphone and the auxiliary equipment. However, it may be appreciated that the wires or cable may also be retained on the exterior surface of the microphone stand, such as by a series of clips, or tubing attached to the microphone stand, which may flex with the microphone stand.

The microphone stand may include a connector 106 at the base or near the bottom of the stand 104 to connect the wires to the auxiliary systems. The connector may include, for example, a male or female XLR connector, such as a female XLR-3 or 5 pin connector. However, other connectors may be utilized as well, such as a USB connector, or a wireless transmitter, which may communicate with a wireless receiver via radio frequency such UHF or VHF frequencies as well as via communication protocols such as Bluetooth, ZigBee or other wireless protocols, such as infrared communication. It may be appreciated that the connector may be positioned, as illustrated in the base of the elongated portion 110, or the connector may be positioned in the base 108, itself, or anywhere along the elongated portion 110. If a wireless transmitter is present, the wireless transmitter may be positioned close to the microphone 102 at the top of the stand, distal to the base 108; however, it may be appreciated that such a transmitter may be positioned at numerous locations on or within the stand.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A microphone system, comprising:
an elongated portion having a proximal end and a distal end defining a channel therethrough, wherein said elongated portion comprises at least one relatively rigid section and at least one relatively flexible section;
a base affixed to said proximal end of said elongated portion; and
a microphone affixed to said distal end of said elongated portion.

2. The microphone system of claim 1, further comprising a connector affixed to said elongated portion in electrical communication with said microphone.

3. The microphone system of claim 2, wherein said connector is affixed to said proximal end of said elongated portion.

4. The microphone system of claim 2, wherein said connector is a XLR connector.

5. The microphone system of claim 1, wherein said microphone is wireless.

6. The microphone system of claim 1, wherein said microphone is removable.

7. The microphone system of claim 1, further comprising a second relatively rigid section and a sleeve slide-able along said second relatively rigid section.

8. The microphone system of claim 7, wherein said sleeve, when positioned distally from said base prevents at least a portion of said at least one relatively flexible section from flexing.

9. The microphone system of claim 7, wherein said sleeve is concentric to said second relatively rigid section.

10. The microphone system of claim 1, wherein said elongated member is removably affixed to said base.

11. The microphone system of claim 1, wherein said base includes feet.

12. The microphone system of claim 1, wherein said relatively flexible section comprises gooseneck tubing.

13. The microphone system of claim 1, wherein said relatively flexible section includes at least one mechanical joint.

14. The microphone system of claim 1, wherein the maximum diameter of said elongated portion is 6.0 cm.

15. The microphone system of claim 1, wherein said relatively rigid section has a first flexural modulus F₁ and said relatively flexible section has a second flexural modulus F₂, wherein F₁>F₂.

16. The microphone system of claim 1, wherein said relatively rigid section has a first modulus of elasticity M₁ and said relatively flexible section has a second modulus of elasticity M₂, wherein M₁>M₂.

17. The microphone system of claim 1, further comprising a collar positioned over at least two of said sections.
